(19) United States
(12) Patent Application Publication
(10) Pub. No.: US 2006/0034513 A1
(43) Pub. Date: Feb. 16, 2006

(54) View assistance in three-dimensional ultrasound imaging

(75) Inventors: Anming He Cai, San Jose, CA (US); Desikachari Nadadur, Issaquah, WA (US); Diane S. Paine, Redmond, WA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 10/898,658

(22) Filed: Jul. 23, 2004

(51) Int. Cl. G06K 9/34

(52) U.S. Cl. 382/173

(57) ABSTRACT

Standardized or preset views for a given application are used to assist in volumetric scanning and diagnosis. By displaying one or more images of a standard view during acquisition, the scan is guided to assure proper positioning of the volumetric scan. The location of a user identified view within the volume is used to determine the location of an additional view. The spatial interrelationship of the views within the standard or preset set of views allows generation of images for each of the views after the user identification of one of the views within the volume. Identification of landmarks associated with a view may be used for more efficient or accurate feature recognition, more likely providing images for the standard views.

### BACKGROUND

The present invention relates to assisting diagnosis in three-dimensional ultrasound imaging. In particular, diagnostically significant information is extracted from ultrasound data representing a volume.

For diagnosis with ultrasound images, a set of interrelated images may be acquired. For example, the American Society of Echocardiography (ASE) specifies standard two-dimensional tomograms for fetal and adult echocardiograms. One standard set includes a long axis view, a short axis view, an apical 2 chamber (A2C) view and an apical 4 chamber (A4C) view. Other standardized sets for a same application or different applications may be used. The standard may be set by a national organization, local medical group, insurance company, hospital or by an individual doctor.

In two-dimensional imaging, a clinician positions a transducer at various locations to acquire images at the desired views. However, such positioning may be time-consuming and result in images of the same organ at greatly different times rather than a same time. Clinicians may not be familiar with one or more views.

Ultrasound energy may be used for a volumetric scan (e.g., three- or four-dimensional imaging). A volume is scanned at a substantially same time. The data representing the volume may be used to generate various images. For example, a three-dimensional representation of the volume is rendered using projection or surface rendering. User control or manual cropping tools may be used to alter the rendering. The data representing the volume may also be used to generate orthogonal multi-plane images. Two orthogonal two-dimensional planes are positioned within the volume. The data associated with each of the planes is then used to generate two two-dimensional images. Rendering software may allow for users to position and select an arbitrary plane through the volume for generating a two-dimensional image. Where the volume scan included scanning along a plurality of different planes and different positions within the volume, images associated with each of the component frames may be separately generated. A plane may be tilted or positioned in different locations relative to the volume.

Bi-plane imaging may be provided where two orthogonal planes corresponding to an azimuth and elevation planes are used to generate images during volume acquisition. The planes are positioned within the volume as a function of the transducer position.

In one system, the volume is scanned. After obtaining data representing the volume, the user input provides an indication of the region, organ, tissue or other structure being imaged. For example, the user indicates the heart is being imaged. A template is then used to match with the data, providing an orientation and position of the feature within the volume. Two-dimensional images for different planes through the recognized anatomy are then generated automatically.

### BRIEF SUMMARY

By way of introduction, the preferred embodiments described below include methods for assisting three-dimensional ultrasound imaging. Standardized or preset views for a given application are used to assist in volumetric scanning and diagnosis. By displaying one or more images of a standard view during acquisition, the scan may be more appropriately guided to assure proper positioning of the volumetric scan. The location of a user identified view within the volume is used to determine the location of an additional view. The spatial interrelationship of the views within the standard or preset set of views allows generation of images for each of the views after the user identification of one of the views within the volume. Identification of landmarks associated with a particular view may be used for more efficient or accurate feature recognition, more likely providing images for the standard views.

In a first aspect, a method is provided for assisting three-dimensional ultrasound imaging. A first location of a first view within a volume is determined as a function of a second location of a user-identified view within the volume. The first location is different than and non-orthogonal to the second location. An image of the first view is generated.

In a second aspect, a method is provided for assisting three-dimensional ultrasound imaging. A volume is scanned with ultrasound energy. A set of images representing regions with different spatial locations within the volume are displayed during the volume scan. The set of images correspond to preset spatial relationships within the volume.

In a third aspect, a method is provided for assisting three-dimensional ultrasound imaging. A volume is scanned with ultrasound energy from an acoustic window. A first plane of a first standard view associated with the acoustic window is identified relative to the volume. A second plane of a second standard view associated with the acoustic window is automatically extracted as a function of the first plane. The second plane is different than and non-orthogonal to the first plane.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for assisting diagnosis with three-dimensional ultrasound imaging;

FIG. 2 is a flow chart diagram of one embodiment of a method for assisting three-dimensional ultrasound imaging;

FIG. 3 is a perspective view representation of a heart and associated planes of a standard set of views;

FIG. 4 is a graphical representation of the relationship between four different standard views in one embodiment;

FIG. 5 is a graphical representation of a display of images corresponding to the four different views shown in FIG. 4;

FIGS. 6 and 7 show two different embodiments of displaying images corresponding to the different views shown in FIG. 3; and

FIG. 8 represents a perspective view of one embodiment of the relationship of a set of standard views of the heart where all the views are in a non-orthogonal configuration.

### DETAILED DESCRIPTION OF THE DRAWINGS AND PRESENTLY PREFERRED EMBODIMENTS

By having preset spatial relationships of planes for different views, volume acquisition may be assisted by displaying images corresponding to one or more of the views. The scanning is guided by the view, such as the user orientating a transducer until a recognizable view is provided by a two-dimensional image. Other views of a standard set are then automatically provided given the spatial relationship between the different views. Immediate feedback is provided to the user for confirming desired volumetric scanning. In addition to or alternative to assisting in acquisition, the spatial relationship may be used to identify the position of planes corresponding to standard views within a volume in non-real time. The user identified view is used to determine other views. Where a user may more accurately identify one view, other views are provided without requiring user recognition. Accordingly, more inexperienced clinicians may provide desired images based on recognizing only one or less than all of the views of a set. The location of the different views relative to each other can then be automatically extracted using user placed landmarks to determine the orientation of the heart or other organs, and templates to match and identify the views whose location can be manually refined by the user.

FIG. 1 shows one embodiment of a system 10 for assisting in three-dimensional ultrasound imaging of a volume. The system 10 includes a transducer 12, a beamformer system 14, a detector 16, a 3D rendering processor 18, a display 20 and a user input 22. Additional, different or fewer components may be provided, such as providing the 3D rendering processor 18 and the display 20 without other components. In another example, a memory is provided for storing data externally to any of the components of the system 10. The system 10 is an ultrasound imaging system, such as a cart based, permanent, portable, handheld or other ultrasound diagnostic imaging system for medical uses, but other imaging systems may be used.

The transducer 12 is a multidimensional transducer array, one-dimensional transducer array, wobbler transducer or other transducer operable to scan mechanically and/or electronically in a volume. For example, a wobbler transducer array is operable to scan a plurality of planes spaced in different positions within a volume. As another example, a one-dimensional array is rotated by hand or a mechanism within a plane along the face of the transducer array or an axis spaced away from the transducer array for scanning a plurality of planes within a volume. As yet another example, a multidimensional transducer array electronically scans along scan lines positioned at different locations within a volume. The scan is of any formats, such as sector scan along a plurality of frames in two dimensions and a linear or sector scan along a third dimension. Linear or vector scans may alternatively be used in any of the various dimensions.

The beamformer system 14 is a transmit beamformer, a receive beamformer, a controller for a wobbler array, filters, position sensor, combinations thereof or other now known or later developed components for scanning in three-dimensions. The beamformer system 14 is operable to generate waveforms and receive electrical echo signals for scanning the volume. The beamformer system 14 controls the beam spacing with electronic and/or mechanical scanning. For example, a wobbler transducer displaces a one-dimensional array to cause different planes within the volume to be scanned electronically in two-dimensions.

The detector 16 is a B-mode detector, Doppler detector, video filter, temporal filter, spatial filter, processor, image processor, combinations thereof or other now known or later developed components for generating image information from the acquired ultrasound data output by the beamformer system 14. In one embodiment, the detector 16 includes a scan converter for scan converting two-dimensional scans within a volume associated with frames of data to two-dimensional image representations. In other embodiments, the data is provided for representing the volume without scan conversion.

The three-dimensional processor 18 is a general processor, a data signal processor, graphics card, graphics chip, personal computer, motherboard, memories, buffers, scan converters, filters, interpolators, field programmable gate array, application specific integrated circuit, analog circuits, digital circuits, combinations thereof or any other now known or later developed device for generating three-dimensional or two-dimensional representations from input data in any one or more of various formats. The three-dimensional processor 18 includes software or hardware for rendering a three-dimensional representation, such as through alpha blending, minimum intensity projection, maximum intensity projection, surface rendering, or other now known or later developed rendering technique. The three-dimensional processor 18 also has software for generating a two dimensional image corresponding to any plane through the volume. The software may allow for a three-dimensional rendering bounded by a plane through the volume or a three-dimensional rendering for a region around the plane. The three-dimensional processor 18 is operable to render an ultrasound image representing the volume from data acquired by the beamformer system 14.

The display 20 is a monitor, CRT, LCD, plasma screen, flat panel, projector or other now known or later developed display device. The display 20 is operable to generate images for a two-dimensional view or a rendered three-dimensional representation. For example, a two-dimensional image representing a three-dimensional volume through rendering is displayed.

The user input 22 is a keyboard, touch screen, mouse, trackball, touchpad, dials, knobs, sliders, buttons, combinations thereof or other now known or later developed user input devices. The user input 22 connects with the beamformer system 14 and the three-dimensional processor 18. Input form the user input 22 controls the acquisition of data and the generation of images. For example, the user manipulates buttons and a track ball or mouse for indicating a viewing direction, a type of rendering, a type of examination, a specific type of image (e.g., an A4C image of a heart), an acoustic window being used, a type of display format, landmarks on an image, combinations thereof or other now known or later developed two-dimensional imaging and/or three-dimensional rendering controls. In one embodiment, the user control 22 is used during real time imaging, such as streaming volumes (i.e., four dimensional imaging) are acquired. In other embodiments, the user control 22 is used for rendering from a previously acquired set of data now stored in a memory (i.e., non-real time imaging).

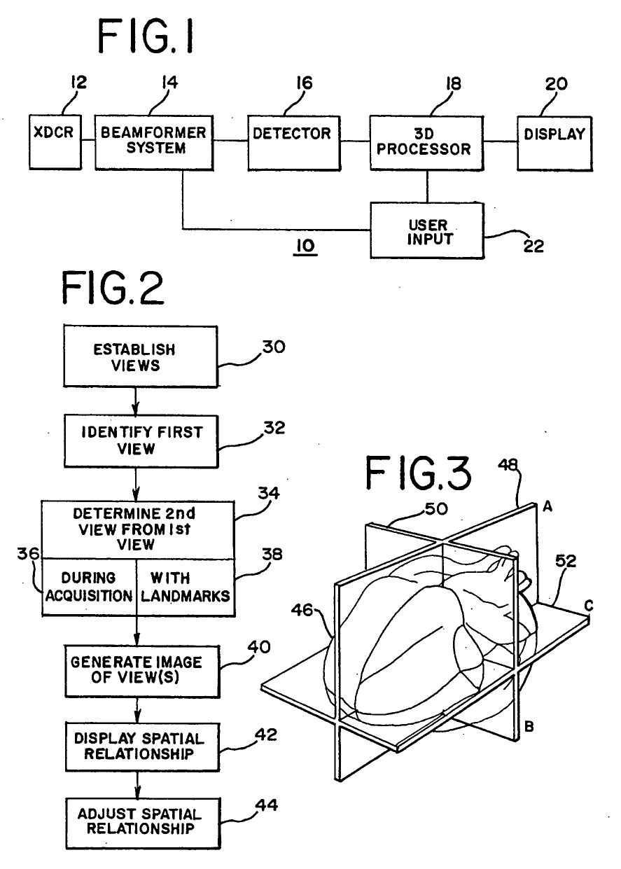

FIG. 2 shows one embodiment of a method for assisting three-dimensional ultrasound imaging. Different, additional or fewer acts may be provided in the same or different order than shown in FIG. 2. For example, acts 42 and 44 are skipped. As another example, both acts 36 and 38 are skipped, or used independently of each other. The method of FIG. 2 is implemented using the system 10 of FIG. 1 or a different system.

In act 30, a set of standard views and corresponding spatial relationships are established. The set of standard views includes two or more preset, different views. The views may correspond to one-dimensional, two-dimensional or three-dimensional imaging. Each different view corresponds to a different imaging location, such as two two-dimensional planes at different positions within a same volume.

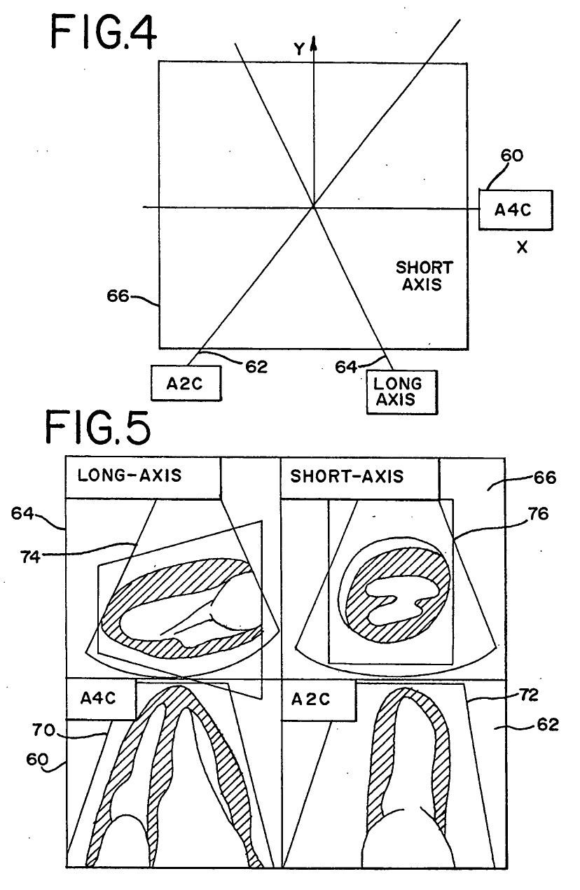

The standard views are standards based on any individual or organization. For example, a medical organization associated with a particular application, group of applications, ultrasound imaging, imaging, or other organizations may establish different sets of views useful for diagnosis. FIGS. 3, 4 and 8 graphically represent different views of different standard sets and the corresponding spatial relationships within a volume for stress echo examination. The heart is represented at 46. A plurality of two-dimensional planes is defined relative to the heart. For example, three planes 48, 50 and 52 each orthogonal to each other provide cross-sections along each of three dimensions of the heart 46. The cross-sections may be oriented such that different information is provided. FIG. 3 shows a set of three standard views and their associated orthogonal spatial relationship. FIG. 4 shows a set of four standard views and corresponding spatial relationships. For example, the A4C plane 60 is an azimuthal plane with a central elevation location relative to the heart. The A2C view 62 has approximately 90° (may be non-orthogonal) rotation towards the elevation plane from the A4C view 60. The long axis view 64 has an additional about 15° rotation (non-orthogonal) from the A2C view 62. The short axis view 66 corresponds to a C plane relative to the view from the transducer. As shown in FIG. 4, the transducer is positioned above the figure. Non-orthogonal includes relationships of regions, lines, or planes that are other than 90° angle to each other.

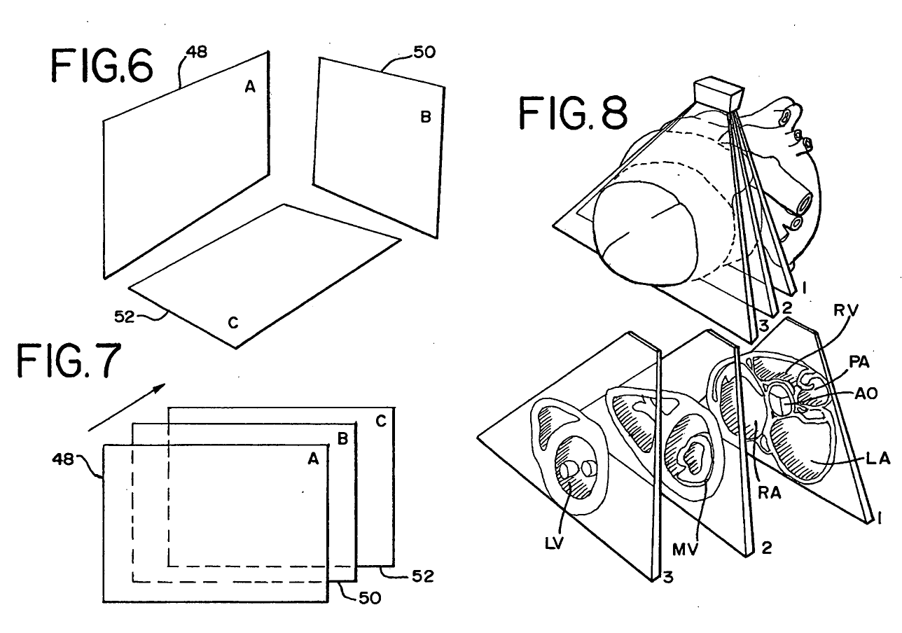

Other sets of standard views for a same or different applications may be used. For example, a plurality of non-orthogonal planes that are at slight angles, such as 10° or less, to each other through a same region of the heart or other organ are provided as the standard views as shown in FIG. 8. Different orientations may be used for different sets of views. For example, an elevation center plane and planes within +15° and −15° elevation angles are provided where one plane provides an image of the left ventricle, another plane provides an image of the mitrol valve and third image provides information for the right atrium, left atrium, the pulmonary valve, pulmonary artery, and right ventricle.

Different sets of standard views may be provided for different acoustic windows in a same application. For example, cardiac imaging of the heart may provide for three or four different acoustic windows. One acoustic window is positioned by the neck, another by the sternum and two between different ribs. Other acoustic windows may be used, such as associated with imaging from the esophagus using a transesophageal probe. Different acoustic windows may be provided for different applications, such as for imaging different organs or body structures.

The corresponding spatial relationships are provided through experimentation, definition as a standard or known structural relationships. While some variation may be provided between different patients in the size, shape and orientation of an image organ, standard views may allow for likely identification of appropriate locations associated with each of the standard views.

Other sets of views may include user established standards or preset views. The user inputs a spatial relationship for one or more views. For example, the user desires a view of the heart not typically obtained using another standard set of views. The user inputs a spatial relationship of the desired view to a known view, such as a user identifiable A4C view. An algorithm provides tools for the user to encode the relative positions of non-standard views with respect to at least one standard view (e.g., A4C) into the system. By inputting the spatial relationship, the set of views includes a user set standard view. Alternatively, the set of views includes only user established views. Other information may be input by the user. For example, the user creates templates and landmark descriptions for these user established views using a training or other image data set. These templates, landmark descriptions and/or the training image data may be used in automatically identifying the non-standard views relative to a specified standard view when new image data is acquired. After at least one non-standard view is thus described, it can be used as if it were a standard view, in describing other non-standard views. This enables the system to function properly when only user established views are used by the clinician.

In act 32, a location of one view associated with an acoustic window or application is identified. For example, a plane associated with a standard view is identified. In the example provided in FIG. 4, a plane for two-dimensional imaging associated with the A4C view 60 is identified. Other planes, lines, points, volumes or regions may be identified. The identification is performed in real time or non-real time. For example, a user manipulates a previously acquired set of data and associated volume rendered image to identify from saved data. Using editing tools or other three-dimensional imaging software, the user identifies a plane or other view relative to a displayed three-dimensional image. The user manipulates the data to identify a recognizable image, such as an image corresponding to one of a plurality of standard views associated with an application. The spatial relationship of the identified view to the volume is then obtained or known. As an alternative to user input to identify a view, software or other algorithms may be provided for automatically identifying a view from the volume, such as by using a pattern or correlation matching of a template to the data representing the volume.

For real time acquisition and imaging, a view is identified in response to user input or automated processes. A volume is scanned with ultrasound energy from an acoustic window. The acquired data is then used to generate a three-dimensional or other image. For example, both a three-dimensional rendering as represented in FIG. 3 and a plurality of two-dimensional images 70, 72, 74 and 76 shown in FIG. 5 are displayed at a substantially same time. In one embodiment, a single button is depressed to enable imaging of the different views within a set of views at a substantially same time while acquiring ultrasound data. In an alternative embodiment, only a single or a sub-set of the images or renderings are displayed. The user positions the transducer until the image of the desired view is obtained. For example, the user positions a transducer until an appropriate image 70 of the A4C view 60 is displayed. Where other images are also displayed, the known spatial relationship of the different views 60-66 is used to determine what data to use for generating the corresponding images 70-76. By appropriately positioning the transducer to provide a desired image for a given view, the other views more likely also represent desired information corresponding to the standard views.

In act 34, a location of a view within a volume is determined as a function of the location of the user identified or other view within the volume. The locations of the different views are different and may or may not be orthogonal. Since the spatial relationship of the different views within a set of standard or preset views is known and stored in a memory, user identification of one view provides the locational information for other views relative to the user identified view. Any number of different views may be determined based on spatially locating a first view. By identifying the acoustic window and/or the desired set of views, any number of views within the set may be determined by identifying the location or position of one view within the set. Identification of the acoustic window indicates a set or a plurality of different sets. Identification of a set with or without corresponding acoustic window information allows for the determination of spatial relationships of a known view to other views.

In the example embodiment of FIG. 4, one of the views, such as the A4C view 60, and the associated image 70 are examined, and the transducer is repositioned until a desired image 70 is provided. The other views 62 through 66 and associated images 72 through 76 are obtained as a function of planes positioned within the volume based on the spatial relationships to the user identified A4C view 60. One or more of the planes may be orthogonal, parallel, more orthogonal than parallel or more parallel than orthogonal to the user identified view. In other embodiments, all of the views are more orthogonal or more parallel to the user identified view.

The different views are determined automatically in response to user identification of the user identified view. For example, a processor obtains the spatial relationship from memory and identifies data corresponding to the different views. In one embodiment, the location relative to the volume of the different views within a set of standard or preset views is determined automatically in act 36 by the positioning of the transducer during imaging. By displaying an image associated with one desired view and positioning the transducer until the image corresponds to desired tissue structure, the various views are automatically positioned as a function of position of the transducer (e.g., acoustic window being used) and the spatial interrelationships. By the user identifying the location of one view relative to the volume, the position of the other views is automatically determined. Referring to FIG. 5, all or a subset of the different views of a set of standard views is displayed. The user aligns one or more of the views with the tissue structures corresponding to the view using the associated images to determine the location and data associated with other views. Different views provide images of the anatomy from different perspectives or different cross sections. The properly positioned views may then be recorded, printed out or displayed for diagnosis.

Other parameters may be altered based on the determined positions of the different views. For example, the volume scan rate is increased once the position of the views is determined. The volume scan rate is increased by limited the location and/or depth of scan lines used to image the volume. By scanning where needed to acquire data for the desired views and desired images of the views, less time may needed to scan portions of the volume not being imaged. For example, using the standard views shown in FIG. 5, data is acquired at a depth of 1 cm or less beyond the short axis view for scan lines not intersected by the other views. Scan lines not intersected by the other views and on an outer portion of the short axis view may not be scanned (e.g., only acquire a region of the short axis view plane likely to include information of interest). Scan lines intersecting the other views may be limited in depth or not used where the scan lines are not likely to include information of interest, such as at the edges of the views.

In another embodiment for automatically extracting the position of one plane or view as a function of a position of a different plane or view, landmarks are used in act 38. In real time or non-real time, the user identifies one of the views within a set. An image corresponding to the view is displayed, such as by the user slicing or arbitrarily positioning planes or volumes for rendering within the scan volume. One or more landmarks associated with the identified view or image are then provided as input. For example, user input identifying a plurality of landmarks within the image is received. The landmarks entered may depend on the view being used. For example in an A4C view, three or more points are identified associated with the lateral tricuspid, lateral mitrol annulus, the crux of the heart and the LV apex. Other landmarks may be used. Continuous landmarks associated with tracing an outline or identifying a border automatically or with user input may also be used. In alternative embodiments, a processor automatically identifies various landmarks using pattern matching or correlation with a template. Where automated landmarks are used, the user indicates that a given image in an associated view position is of a particular view. The processor then identifies landmarks within the view for determining the orientation and/or size of the anatomy.

The landmarks are used to determine an orientation or size of the organ or structure being imaged within the volume. By spatially positioning the orientation or size of the anatomy as a function of the selected view with the volume and the landmarks, a more refined determination of the location of other views may be used. For example, the spatial relationship between different views is a function of structure within the anatomy. Where the heart or other organ is at a different orientation, different spatial relationships may be provided. The landmarks allow for selection of an appropriate spatial relationship. In fetal echocardiography, the orientation of the fetal heart relative to the transducer may vary depending on fetus position. Landmarks are used to determine the orientation of the fetal heart relative to the transducer. The desired views may then be located given the orientation and spatial relationships.

Further refinement of the spatial relationships is provided by allowing adjustment of the spatial relationship of one view relative to another view. In act 44, the adjustment corresponds to manual or user input based adjustment. As an alternative, the spatial relationship is adjusted automatically or with a processor. Spatial relationship provided with a set of views provides an approximate positioning of one view relative to another view. A preset spatial relationship allows extraction of approximate positions of different planes or regions. A template based on the structure within an image for a different view is matched to the corresponding data. Sample images from an image database, a likely geometric shape or other templates may be matched to identify a translation and/or rotation associated with adjustment of the relative spatial locations for a given examination. By matching the template with data representing planes or other regions near the approximated position, a more optimum position may be identified. Any of various matching may be used, such as correlation or pattern recognition.

In act 40, one or more images of the different views are generated. Different viewing formats may be provided. For example, different images for two or more different views are displayed substantially simultaneously, such as adjacent to each other. FIG. 5 shows generating different images corresponding to different standard views, including a user identified view, at a substantially same time. Substantially is used to account for different update rates or refreshing different images at different times. The user perceives the images to be updated in real time or regularly. Different views and the corresponding images are generated substantially simultaneously adjacent to each other for non-real time imaging as well, such as displaying frozen images at a same time in adjacent locations. In one embodiment, all of the views and associated images within a set of standard or preset views are displayed at a same time, but fewer than all of views may alternatively be displayed at a same time.

In one embodiment represented in FIG. 6, the images are generated with viewing angles corresponding to a spatial relationship relative to the volume and each other. An image provided for each of the views 48, 50 and 52 are provided at different but adjacent locations on a display substantially simultaneously. FIG. 6 represents the generation of images for the different views as two-dimensional images. The views 48, 50 and 52 are provided at a perspective or viewing direction corresponding to the position of the views 48, 50 and 52 shown in FIG. 3. For sets of views with different spatial relationships, different relative viewing angles may be provided. As an alternative, the display of FIG. 5 provides the images 70-76 and associated views 60-60 in a quadrant or other format unrelated to the spatial relationships. In another embodiment represented in FIG. 7, the images and corresponding views 48, 50 and 52 are displayed in sequence. The generation of the images cycles through the sequence at any of various rates, such as rates set by the user or the system. The user may cause the sequence to cycle in any direction. By displaying the images in sequence, the images may be displayed on a full screen display area.

The generated images are in any now known or later developed format. For example, an M-mode, B-mode, Doppler mode, contrast agent mode, harmonic mode, flow mode or combinations thereof is used. One-, two- or three-dimensional imaging may be provided. For example, a two-dimensional plane is used as a boundary for rendering a three-dimensional representation. One or more of the views of a standard set of views may be represented with a three-dimensional volume rendering bounded by the location of the view. As another example, a plurality of adjacent planes or grouping of data around a location of a particular view is used for rendering a three-dimensional representation of a slice. As yet another example, a two-dimensional image is generated from data along a two-dimensional plane. In one embodiment, one or more views are displayed as two-dimensional views and at least another view is volume rendered with an identified plane acting as a front cut-plane or boundary for the rendering. A three-dimensional rendering of the entire volume may be displayed at a same time or sequentially with images generated for any of the standard or preset views. The different images displayed for different views or a three-dimensional rendering may use the same or different light sources and the same or different viewing directions for generation of the images. Displayed images may be overlapping, such as one image overlapping another in an opaque or semi-opaque manner. A pulse or continuous wave image, such as provided for spectral Doppler imaging, may be provided as one of the views or in addition to any of the other generated images.

In act 42, the spatial relationship of the user identified view to other views is displayed. For example, the display format of images shown in FIG. 6 indicates a relative spatial relationship. As another example, a three-dimensional rendering is provided with the position of the different views relative to each other and the rendering indicated within the image. FIG. 3 shows one such display. A textual description of the spatial relationship rather than a visual display may be provided. Alternatively, the spatial relationship of the various views within a set of views to each other is not provided to the user.

In act 44, the spatial relationship between different views is adjusted as a function of user input. After or during the display of images corresponding to the different views, the user may indicate an adjustment, such as a tilting, rotating or translation along any dimension or axis of a position of a view relative to another view. The spatial relationship is adjusted for a given examination or adjusted and stored as part of the set of views for later examinations. Adjustment allows for optimizing views for different patient conditions, such as orientations or size differences between different patients. The adjustment is performed after data is acquired, or while data is acquired for real time imaging. The adjustment may be stored for a given set of data representing a volume for a later use and diagnosis. In one embodiment, the user selects one view and identifies the location of that view relative to the volume. The spatial relationship between the user identified view and other views are adjusted as desired in real time or non-real time.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I claim:

1. A method for assisting three-dimensional ultrasound imaging, the method comprising:
(a) determining a first location of a first view within a volume as a function of a second location of a user-identified view within the volume, the first location different than and non-orthogonal to the second location; and
(b) generating a first image of the first view.

2. The method of claim 1 wherein (a) comprises determining the first view as a first two-dimensional plane within the volume as a function of a spatial relationship with a second plane corresponding to the user-identified view within the volume.

3. The method of claim 1 further comprising:
(c) generating a second image of the user-identified view substantially simultaneously with the first image.

4. The method of claim 1 wherein (a) comprises determining at least the first and a second view within the volume as a function of a spatial relationship with the user-identified view, the second view spatially different than the first view.

5. The method of claim 1 wherein (a) comprises automatically determining the first view in response to user identification of the user-identified view.

6. The method of claim 1 wherein (b) comprises generating the first image and a second image corresponding to the user-identified view, the second image displayed adjacent to the first image at a substantially same time.

7. The method of claim 6 wherein (b) comprises displaying a set of two-dimensional images comprising the first and second images during a three-dimensional scan, and wherein (a) comprises positioning a transducer during (b) such that the second image is of a user identifiable anatomy.

8. The method of claim 7 wherein (b) comprises displaying a standard heart imaging set of two-dimensional images, the set comprising a four chamber view, a two chamber view, a long axis view and a short axis view.

9. The method of claim 6 wherein (b) comprises generating the first and second images as two-dimensional images with a viewing angle corresponding to a spatial relationship of the user-identified view relative to the first view.

10. The method of claim 1 wherein (b) comprises generating the first image and a second image corresponding to the user-identified view, the second image displayed in sequence with the first image.

11. The method of claim 1 wherein (b) comprises generating the first image as a rendering bounded by the first view.

12. The method of claim 1 further comprising:
(c) adjusting as a function of user input a spatial relationship of the first view to the user-identified view.

13. The method of claim 1 wherein (a) comprises:
(a1) displaying a second image corresponding to the user-identified view;
(a2) receiving user-input landmarks relative to the second image; and
(a3) determining the first view as a function of the user-identified view and the user-input landmarks.

14. The method of claim 1 further comprising:
(c) adjusting a spatial relationship of the first view to the user-identified view, the adjustment being a function of matching a template to the data for the first view.

15. The method of claim 1 further comprising:
(c) receiving user input identifying the user-identified view from saved data representing the volume at a previous time.

16. The method of claim 1 further comprising:
(c) receiving user input of a spatial relationship of the first view to the user-identified view prior to performing (a).

17. The method of claim 1 further comprising:
(c) establishing a set of standard views and corresponding spatial relationships; and
(d) receiving user input relating the user-identified view to a first one of the standard views;
wherein (a) comprises determining the first view as a second one of the standard views as a function of the corresponding spatial relationship with the first one of the standard views.

18. The method of claim 1 wherein (a) comprises determining an orientation of anatomy as a function of the user-identified view spatial relationship with the volume and landmarks.

19. The method of claim 1 further comprising:
(c) displaying a spatial relationship of the user-identified view to the first view.

20. The method of claim 1 wherein (a) comprises determining the first view as more orthogonal than parallel to the user-identified view.

21. The method of claim 1 wherein (a) comprises determining the first view within the volume as a function of the user-identified view and an acoustic window.

22. A method for assisting three-dimensional ultrasound imaging, the method comprising:
(a) scanning a volume with ultrasound energy;
(b) displaying a set of images representing regions with different non-orthogonal spatial locations within the volume during (a);
wherein the set of images correspond to pre-set spatial relationships within the volume.

23. The method of claim 22 further comprising:
(c) positioning a transducer during (a) and (b) such that a first one of the images is of a particular user identifiable anatomy, at least a second one of the images being of the anatomy from a different viewing direction.

24. The method of claim 22 wherein (b) comprises displaying the set of images with spatial locations corresponding to spatial interrelationships of a standard diagnosis set of images.

25. A method for assisting three-dimensional ultrasound imaging, the method comprising:
(a) scanning a volume with ultrasound energy from an acoustic window;
(b) identifying a first plane of a first standard view associated with the acoustic window relative to the volume; and
(c) automatically extracting as a function of the first plane a second non-orthogonal plane of a second standard view associated with the acoustic window, the second plane being different than the first plane.

26. The method of claim 25 further comprising:
(d) displaying the first standard view; and
(e) receiving user input identifying a plurality of landmarks within the first standard view;
wherein (c) comprises extracting as a function of the first plane and the plurality of landmarks.

27. The method of claim 25 wherein (c) comprises:
(c1) extracting an approximate position of the second plane as a function of a pre-set spatial relationship with the first plane;
(c2) comparing a template corresponding to the second standard view to data sets representing planes near the approximate position; and
(c3) selecting the second plane as a function of the comparison.
